(19) United States
(12) Patent Application Publication
(10) Pub. No.: US 2011/0188490 A1
(43) Pub. Date: Aug. 4, 2011

(54) Method and apparatus for data transmission

(75) Inventor: Elias Bjarnason, Grasbrunn (DE)

(73) Assignee: Lantiq Deutschland GmbH, Neubiberg (DE)

(21) Appl. No.: 13/015,753

(22) Filed: Jan. 28, 2011

(30) Foreign Application Priority Data
Jan. 29, 2010 (DE) 10 2010 001 358.7

(51) Int. Cl. H04J 3/06

(52) U.S. Cl. 370/350

(57) ABSTRACT

Method and apparatuses are provided for frame-based voice data transmission. In one exemplary embodiment, synchronization information is transmitted in only some of the transmitted frames in an operating mode without payload data transmission.

### PRIORITY

This application claims priority to the German patent application DE 102010001358.7 filed 29of Januray, 2010, and entitled “Verfahren and Vorrichtungen zur Datenübertragung”.

### BACKGROUND

The present invention relates to method and apparatuses for data transmission, in particular for frame-based transmission of voice data. Frame-based transmission of voice data such as this is used, for example, in cordless telephones which, for example, operate in accordance with the DECT Standard (Digital Enhanced Cordless Telecommunications).

Cordless telephones such as these typically have a base station and a mobile part. During a telephone call, the base station receives voice signals for example via the public telephone network or else, in the case of so-called IP telephony, as packet-based voice data from the Internet, codes or transcodes the voice data, if this is necessary, and transmits this data as voice frames in wire-free form to the mobile part. The voice data is decoded and output via a loudspeaker in the mobile part.

On the opposite communication path, the mobile part receives voice for example via a built-in microphone, codes this and transmits this, likewise on a frame basis, to the base station. The base station decodes the voice data and converts it to suitable voice signals for a network, for example to analogue voice signals for the public telephone network, or transcodes the voice data, if this is necessary, and packs the voice data into IP packets when using IP telephony, i.e., VoIP.

In recent years, possible health hazards caused by so-called “electrosmog” have been increasingly publicly discussed. Against this background, it is generally desired to keep the power emitted by the base station and/or the mobile part of a system such as this as low as possible. A power saving such as this is also desirable from the point of view of the life of the rechargeable battery in the mobile part.

When no call is actually taking place, that is to say no voice data need be transmitted between the base station and the mobile part, signals are nevertheless interchanged between the base station and the mobile part. For this purpose, the two different operating modes described in the following text are defined, inter alia, in the ETSI Standards which are relevant for DECT.

A so-called “dummy bearer mode”, that is to say a dummy bearer operating mode, is illustrated schematically in FIG. 4. In this case, in FIG. 4 a first frame is annotated as the frame 0, and a second frame is partially illustrated, and is annotated as the frame 1. In general, in the case of communication based on DECT, 16 frames are in each case combined to form a multiframe. Each frame comprises a first part for communication from the base station to the mobile part, and a second part for communication from the mobile part to the base station. In this operating mode, a so-called dummy bearer 41 is transmitted in the first part of each frame and, for example, may contain synchronization information. In the illustrated example, these dummy bearers are in each case transmitted in a fifth time slot in each frame.

In this operating mode, in a second part of each frame, the base station samples five reception time slots in a sequence of frequency channels, which the respective mobile parts normally know, that is to say five reception channels, and this is annotated as 42 in FIG. 4, and is used, for example, to detect initiation of a telephone call by the mobile part. This sampling of the transmission frequencies is carried out in the illustrated example in the time slots 12, 14, 18, 20 and 22 of each frame.

A relatively high transmission power is emitted, even when no call is being made, by the transmission of the dummy bearers and/or by the transmission of corresponding signals from the mobile part to the base during the second parts of the frames.

In a second operating mode which is defined in the Standard, the so-called “no emission mode”, that is to say an operating mode “without” emissions, sampling of reception channels is carried out in the majority of every second frame, but the dummy bearer is no longer transmitted. This procedure means that, because there are no dummy bearers, there is no need for synchronization between the mobile part and the base station, which means that a relatively long time can pass when an incoming call occurs before a connection can be set up again (up to 2 to 3 seconds in comparison to less than 0.5 seconds in the dummy bearer operating mode). Furthermore, as before, the sampling of the reception channels in the base station results in a relatively high power consumption.

### SUMMARY

One object of the present invention is therefore to provide methods and apparatuses for frame-based data transmission, in which it is possible to reduce the power consumption and/or the emitted power, and which nevertheless allow rapid resumption of communication between a mobile part and a base station.

According to the invention, a method is provided for frame-based data transmission in which synchronization information is transmitted in only some of the frames in an operating mode without payload data transmission.

This results in synchronization being maintained such that, when payload data is once again ready for transmission, the connection can be resumed quickly. On the other hand, this means that the synchronization information is transmitted only in some of the frames and not in all of the frames, thus reducing the required transmission power, and therefore also the power consumption.

In one exemplary embodiment, reception channels are likewise sampled only in some of the frames, wherein the frames in which reception channels are sampled may be identical to the frames in which synchronization information is transmitted, but need not be identical to them.

By way of example, such synchronization information may comprise a synchronization bit sequence and/or identification information.

In one exemplary embodiment, the frames are time-division multiplex frames with a multiplicity of time slots. The synchronization information can then be transmitted in one or more predetermined time slots in the few frames.

In one exemplary embodiment, the data is voice data, and the method is used for communication between a base station and a mobile part.

In one exemplary embodiment, a plurality of frames are combined to form a multiframe, and the synchronization information is transmitted only in some frames in each multiframe, for example only in one frame in each multiframe. A corresponding situation can apply to the sampling of reception channels as mentioned above.

In one exemplary embodiment, the frames and multiframes mentioned above are frames and multiframes of a DECT transmission system.

In other exemplary embodiments, corresponding apparatuses, for example base stations or mobile parts, are provided.

### BRIEF DESCRIPTION OF THE DRAWINGS

The invention will be explained in more detail in the following text using exemplary embodiments and with reference to the attached drawing, in which:

FIG. 1 shows a block diagram of one exemplary embodiment of a communication system according to the invention,

FIG. 2 shows one example of the layout of frames for exemplary embodiments of the present invention,

FIG. 3 shows a diagram to illustrate exemplary embodiments of the present invention, and

FIG. 4 shows a diagram to illustrate a system according to the prior art.

### DETAILED DESCRIPTION

Exemplary embodiments of the present invention will be explained in detail in the following text. In this case, a cordless telephone which operates, for example, in accordance with a DECT Standard such as ETSI 3000-175-1, . . . ,8 is used as an example of a system for implementation of the invention. In other exemplary embodiments, other systems which transmit data, in particular voice data, in data frames and/or on a sample basis can be used, for example mobile telephones which communicate with a base station in accordance with a GSM Standard.

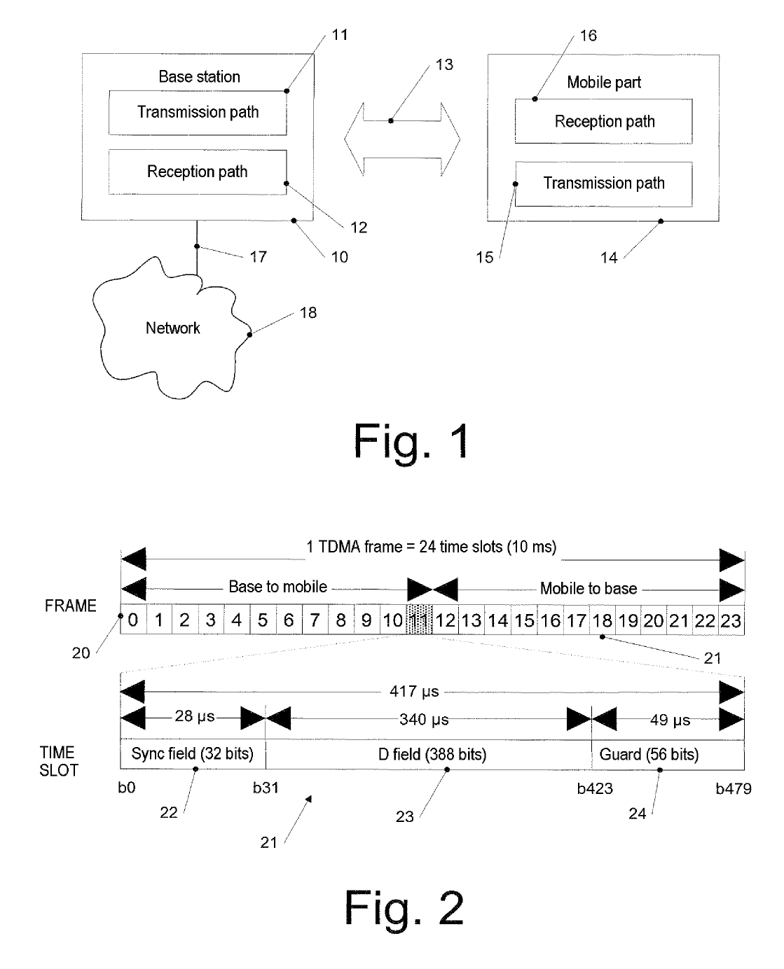

FIG. 1 illustrates a system with a cordless telephone according to one exemplary embodiment of the invention. The cordless telephone in the exemplary embodiment shown in FIG. 1 comprises a base station 10 and a mobile part 14. The base station 10 is connected to a network 18, for example to the public telephone network, via a connection 17, for example a cable-based connection. The base station 10 comprises a transmission path 11 for wire-free transmission of voice data in data frames to the mobile part 14 via a wire-free transmission path 13. Furthermore, the base station 10 comprises a reception path 12 for reception of voice data in data frames from the mobile part 14 via the transmission path 13. The transmission path 11 and the reception path 12 may, for example, comprise elements such as an antenna, transformer, filter, amplifier and the like. Furthermore, the transmission path 11 and the reception path 12 may also have common elements, for example a common antenna.

In a corresponding manner, the mobile part 14 comprises a reception path 16 for reception of voice data frames transmitted by the base station 10 and for outputting corresponding voice signals for example via a loudspeaker, as well as a transmission path 15 for transmission of voice data frames to the base station 10, wherein the voice data may be generated, for example, from voice signals recorded by a microphone in the mobile part 14. The reception path 16 and the transmission path 15 may in turn comprise elements such as amplifiers, transformers, filters and/or one or more antennas, in which case common elements of the transmission path 15 and reception path 16 can also be provided here.

The voice data frames may be time-division multiplex voice data frames in accordance with the DECT Standard. However, the invention is not restricted to this, and it is also possible to use time-division multiplex data frames in accordance with different transmission standards, such as TIA IS 136.2 (Telecommunications Industry Association), or time-division multiplex voice data frames in accordance with a GSM Standard, or else non-standardized data frames. Furthermore, it is also possible to transmit other data than voice data in a corresponding manner.

The layout of a DECT frame 20 is shown in FIG. 2, for illustrative purposes. The frame 20 has a length, for example, of 10 milliseconds and is subdivided into 24 time slots 21, which are numbered successively from 0 to 23 in FIG. 2. By way of example, each time slot has ten frequency cells of which one can normally be used at any given time. The time slots 0 to 11 in each frame are in this case used, in the illustrated example, for data transmission from the base station to the mobile part, while the time slots 12 to 23 are used for transmission from the mobile part to the base station. Each time slot may comprise 480 bits in the illustrated exemplary embodiment.

The time slots 0 to 23 in principle have the same configuration. In the example illustrated in FIG. 2, one of the time slots 21, for example time slot No. 11, is illustrated in more detail. The time slot in the illustrated example has a duration of 417 μs. A first field 22, which comprises bits 0 to 31 (B0 to B31) in the time slot, and lasts, for example, 28 μs, is used as a synchronization field, that is to say for transmission of synchronization data. This synchronization field is followed by a 388-bit long so-called D field 23 with a duration of 340 μs. The D field is used, inter alia, for transmission of payload data, in particular voice data. The D field 23 is followed by a 56-bit long guard section 24.

In DECT systems, 16 such frames are in each case combined to form a multiframe.

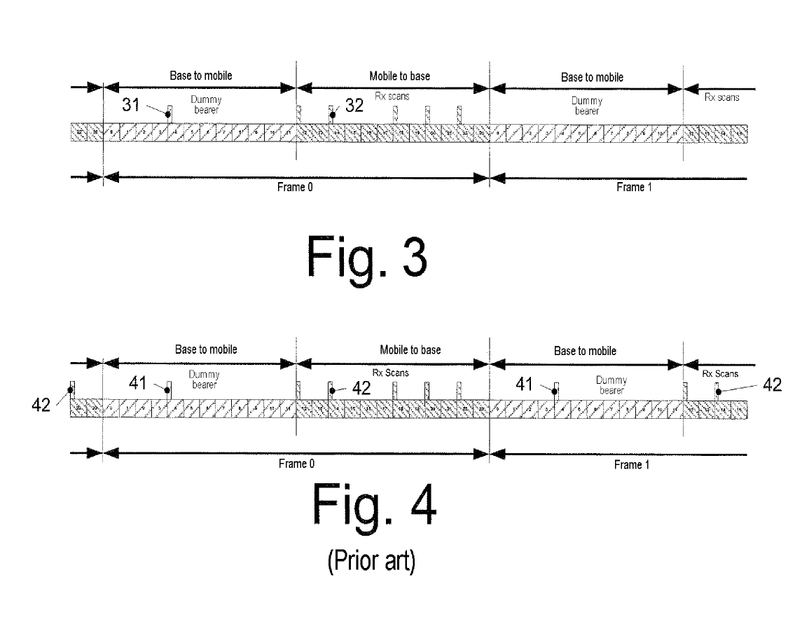

As already explained, the frames illustrated in FIG. 2 are used to transmit voice data during a call. In times in which no call is taking place, the system changes to a rest operating mode. The data transmission in a rest operating mode according to one exemplary embodiment of the invention is illustrated schematically in FIG. 3.

In the exemplary embodiment in FIG. 3, a dummy bearer is transmitted in one time slot, in the illustrated case in the time slot 4 of a first frame (frame 0) of each multiframe, in which case this dummy bearer in one exemplary embodiment contains only synchronization data, for example the synchronization field 22 from FIG. 2. By way of example, the synchronization data may comprise a synchronization bit sequence and/or identification information. However, it may also comprise a D field which, for example, may be empty or may comprise other control information, and a guard section such as the guard section 24 from FIG. 2. The base station does not transmit any data to the mobile part in the other frames 1 to 15 in each multiframe.

In the exemplary embodiment shown in FIG. 3, five free reception channels are likewise sampled only in a first frame of each multiframe, as indicated, by way of example, as the block 32 in FIG. 3. In the example in FIG. 3, this sampling is carried out in the time slots 12, 14, 18, 20 and 22 of the first frame of each multiframe.

Since synchronization information is transmitted in the form of the dummy bearer 31 in only one frame of each multiframe, and free reception channels are also sampled in only one frame of each multiframe, the transmission power can be reduced in comparison to the conventional method discussed in the introductory part of the description with reference to FIG. 4, and the power consumption of the base station can likewise be reduced.

In one exemplary embodiment, a base station can be switched between the rest operating mode as discussed with reference to FIG. 3 and the rest operating mode as illustrated in FIG. 4, or a further rest operating mode such as the “no emission mode” mentioned in the introductory part of the description. This also applies to the mobile part. In one exemplary embodiment, such switching can take place in the base station, when the base station identifies that the mobile part supports the operating mode illustrated in FIG. 3. By way of example, this can be done by the mobile part transmitting a signal to the base station only in a first frame of each multiframe, which signal is then detected during the sampling of the reception channels 32, or the support of the operating mode illustrated in FIG. 3 is signalled to the base station in some other manner.

The corresponding mobile part, such as the mobile part 14 from FIG. 1, can then be designed to carry out synchronization on the basis of the dummy bearer 31, and to transmit signals to the base only at the times which correspond to the sampling processes 32, when the mobile part is in the corresponding operating mode.

The exemplary embodiment illustrated in FIG. 3 should be regarded only as one possible way to implement the present invention. In particular, FIG. 3 relates to the example of DECT frames as illustrated in FIG. 2 and, in other transmission systems, the exemplary embodiment can be appropriately adapted, for example by transmitting synchronization information in only some of the frames, rather than in all of the frames. This also applies to the sampling of reception channels. In yet other exemplary embodiments, it is possible to use more than one frame in each multiframe, for example two or three frames in each multiframe, in order to transmit synchronization information and/or to sample reception channels, and/or only some frames in some multiframes are used for this purpose, for example every n-th multiframe. In addition, the transmission of synchronization information and the sampling of the reception channels need not necessarily take place in the same frame. For example, the dummy bearer 31 could be transmitted in frame 0, and the reception channels 32 could be sampled in frame 1 of each multiframe.

With regard to these variation options, the exemplary embodiments described above should not be interpreted as restricting the scope of the invention.

1. Method for frame-based data transmission of data including voice data, comprising:
transmission of synchronization information in an operating mode without payload data transmission in only some of the transmitted frames.

2. Method according to claim 1, furthermore comprising:
transmission of the voice data in the data frames, using an operating mode with payload data transmission.

3. Method according to claim 1, wherein the synchronization information is transmitted from a base unit to a wireless phone.

4. Method according to claim 1, furthermore comprising:
sampling of reception channels in only some of the frames in the operating mode without payload data transmission.

5. Method according to claim 4,
wherein a plurality of frames are combined to form a multiframe,
wherein the sampling is carried out only in some frames in each n-th multiframe, where n is a positive integer.

6. Method according to claim 5,
wherein the sampling is carried out only in one frame of each multiframe.

7. Method according to claim 1, wherein the data frames are time-division multiplex data frames with a multiplicity of time slots.

8. Method according to claim 1, wherein a plurality of frames are grouped to form a multiframe, wherein the synchronization information is transmitted in the operating mode without payload data transmission only in some frames in each n-th multiframe, where n is a positive integer.

9. Method according to claim 8, wherein the synchronization information is transmitted only in one frame of the multiframe.

10. Method according to claim 1, wherein the data frame is selected from the group consisting of a DECT data frame, a VoIP data frame, and a GSM data frame.

11. Method according to claim 1, furthermore comprising:
transmission of data frames in a further operating mode without payload data transmission, in which synchronization information is transmitted in each of the frames, and
changing to the operating mode without payload data transmission when it is found that a receiver of the synchronization information supports the operating mode without payload data transmission.

12. Method according to claim 1, wherein data is not transmitted in frames which are not within the few frames.

13. Apparatus for transmission of data frames with data including voice data,
having a transmission element for transmission of data frames and a reception element for reception of data frames, wherein the apparatus is designed to transmit synchronization information in only some of the data frames in an operating mode without payload data transmission.

14. Apparatus according to claim 13, wherein the apparatus is designed to sample reception channels only in some of the data frames in the operating mode without payload data transmission.

15. Apparatus according to claim 13, wherein the apparatus is a base unit of a wireless phone.

16. Apparatus according to claim 13, wherein the apparatus is designed to transmit data frames selected from the group consisting of a DECT data frame, a VoIP data frame, and a GSM data frame.

17. Apparatus for frame-based data transmission, having a transmission element for transmission of data frames of data including voice data,
a reception element for reception of the data frames,
wherein the apparatus is designed to maintain synchronization with a further apparatus in an operating mode without payload data transmission on the basis of synchronization information which is received in only some of the frames.

18. Apparatus according to claim 17,
wherein the apparatus is designed to transmit a request to change to an operating mode with payload data transmission only in some predetermined frames in the event of a change to an operating mode with payload data transmission, when in the operating mode without payload data transmission.

19. Apparatus according to claim 17, wherein the apparatus is a wireless phone.

20. Apparatus according to claim 17, wherein the transmission element transmits data frames selected from the group consisting of a DECT data frame, a VoIP data frame, and a GSM data frame.
